(19) United States
(12) Patent Application Publication
(10) Pub. No.: US 2023/0177247 A1
(43) Pub. Date: Jun. 8, 2023

(54) THREE-DIMENSIONAL ROUGHNESS EXTRACTION OF METAL

(71) Applicant: International Business Machines Corporation, Armonk, NY (US)

(72) Inventors: GANGADHARA RAJA MUTHINTI, Albany, NY (US); Koichi Motoyama, Clifton Park, NY (US); Lawrence A. Clevenger, Saratoga Springs, NY (US); Christopher J. Penny, Saratoga Springs, NY (US)

(21) Appl. No.: 17/542,882

(22) Filed: Dec. 6, 2021

(51) Int. Cl. G06F 30/3953; G06F 30/398

(52) U.S. Cl. CPC G06F 30/3953; G06F 30/398; G06F 2119/02

(57) ABSTRACT

A computer-implemented method of assessing roughness in metallic lines of an integrated circuit (IC) is provided. The computer-implemented method includes developing a library of roughness characterizations for metal lines of varying characteristics and dimensions. The computer-implemented method further includes fabricating a testable IC and identifying, in the testable IC, a location of interest (LoI) at which roughness of a metal line within the LoI could impact IC performance. Also, the computer-implemented method includes developing, from the library, a roughness model using the roughness characterizations for those metal lines having characteristics and dimensions corresponding to those of the metal line within the LoI and refining the library and the roughness model based on a comparison of the roughness model and an actual roughness of the metal line within the LoI to obtain a final roughness model.

### BACKGROUND

The present invention generally relates to integrated circuits (ICs), and more specifically, to improving IC fabrication using three-dimensional (3D) roughness extraction of metal structures.

Modern ICs are made up of millions of active devices, such as transistors and capacitors. These devices are initially isolated from one another but are later interconnected together by interconnection structures or lines to form functional circuits. The quality of the interconnection structures can drastically affect the performance and reliability of the functional circuit.

### SUMMARY

Embodiments of the present invention are directed to a computer-implemented method of assessing roughness in metallic lines of an IC. A non-limiting example of the computer-implemented method includes developing a library of roughness characterizations for metal lines of varying characteristics and dimensions. The non-limiting example of the computer-implemented method further includes fabricating a testable IC and identifying, in the testable IC, a location of interest (LoI) at which roughness of a metal line within the LoI could impact IC performance. Also, the non-limiting example of the computer-implemented method includes developing, from the library, a roughness model using the roughness characterizations for those metal lines having characteristics and dimensions corresponding to those of the metal line within the LoI and refining the library and the roughness model based on a comparison of the roughness model and an actual roughness of the metal line within the LoI to obtain a final roughness model.

Embodiments of the present invention are directed to a computer-implemented method of fabricating an IC using assessed roughness in metallic lines. A non-limiting example of the computer-implemented method includes obtaining an IC design, identifying a location of interest (LoI) in the IC design at which roughness of a metal line within the LoI could impact IC performance and applying a final roughness model to the IC design to model a roughness of the metal line within the LoI to determine whether the roughness of the metal line within the LoI could impact IC performance. The non-limiting embodiment of the computer-implemented method further includes executing first processes to fabricate the IC design without regard to limiting metal line roughness at locations other than the LoI and executing second processes for limiting metal line roughness or the first processes to fabricate the IC design within the LoI in accordance with determinations that the roughness of the metal line within the LoI could or will not impact IC performance, respectively.

Embodiments of the invention are directed to an IC. A non-limiting example of the IC includes a substrate, electronic elements deployed on the substrate and metal lines disposed to interconnect the electronic elements to one another. The metal lines include at least first, second and third metal lines of varying scales with substantially similar roughness characteristics.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1A is a flow diagram illustrating a computer-implemented method of assessing roughness in metallic lines of an IC in accordance with one or more embodiments of the present invention;

FIG. 1B is a schematic diagram of a processing circuit capable of executing the computer-implemented method of FIG. 1A in accordance with one or more embodiments of the present invention;

FIG. 2 is a perspective view of an optical simulator for scatterometry of grating structures in accordance with one or more embodiments of the present invention;

FIG. 3 is a flow diagram illustrating a refining of a library and a roughness model to obtain a final roughness model in accordance with one or more embodiments of the present invention;

FIG. 4 is a flow diagram of a computer-implemented method of fabricating an IC using assessed roughness in metallic lines in accordance with one or more embodiments of the present invention; and

FIG. 5 is a graphical illustration of process flows for fabricating an IC in accordance with one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, it is understood that surface roughness on metal lines of an IC can induce significant variation in electrical properties in the functioning that IC. Even in instances where a surface has been processed for smoothness, there will be some degree or level of post-processing surface roughness due to machining and other process limitations that results in the machined or processed surface having a non-planar topography. This is particularly true for metal lines with very small-scale dimensions. In fact, for metal lines of 7 nm, 5 nm and 3 nm with a same degree of roughness, the resistance of the 5 nm metal line will exceed the resistance of the 7 nm metal line and the resistance of the 3 nm metal line will exceed the resistance of the 5 nm metal line. Indeed, the difference between the resistances of the 3 nm and the 5 nm metal lines will actually exceed the difference between the resistances of the 5 nm and the 7 nm metal lines.

With the problem of roughness for small-scale metal lines being understood, it is also understood that inline monitoring and metrology of roughness is critical for process control, yield optimization and reliability. This is because such inline monitoring and metrology of roughness can identify areas of ICs that exhibit relatively large degrees of roughness so that particular fabrication processes can be executed in those areas to limit or reduce roughness. These particular fabrication processes are expensive and time consuming and cannot generally be applied to large areas of ICs or to large numbers of areas. Thus, the inline monitoring and metrology of roughness is necessary to pinpoint areas of concern where the particular fabrication processes should be used so as to avoid increasing the costs and time requirements for IC fabrications.

Unfortunately, existing methods and techniques for inline monitoring and metrology often fail to provide 3D variation in roughness in metal trenches and vias that can have horizontal, vertical, and/or non-planar (or curved) surfaces. As such, for small-scale metal trenches and vias, it is typically difficult to identify areas of roughness that could degrade IC performance. Therefore, unless there is a willingness to execute large-scale fabrication processes that can limit roughness, it is difficult to fabricate ICs that do not have small-scale metal trenches and vias which exhibit limited roughness.

Turning now to an overview of the aspects of the invention, one or more embodiments of the invention address the above-described shortcomings of the prior art by providing for a custom optical critical dimension (OCD) macro design to extract roughness information and which includes an optimized OCD algorithm for accurate optical roughness characterization. A library of roughness characteristics is thus tested and built for various parameters (trench/via critical dimension (CD), height, side wall angle (SWA), etc.) so that an IC design can be monitored for areas of small-scale features that might exhibit high degrees of roughness. This information can be used for roughness calibration with reference metrology and to direct particular fabrication processes to those areas so that the high degrees of roughness can be corrected.

The above-described aspects of the invention address the shortcomings of the prior art by providing complete 3D information for metal line/trench/via characterization with early detection of defects, yield control and optimization. The processes described herein are applicable to multiple BEOL levels and various technologies and further provide for an additional parameter for process tuning and integration.

Turning now to a more detailed description of aspects of the present invention, in designing an IC device, engineers or designers typically rely on computer design tools to help create an IC schematic or design, which can include a multitude of individual devices, such as transistors, coupled together to perform certain functions. To actually fabricate the IC device in or on a semiconductor substrate, the IC device schematic must be translated into a physical representation or layout, which itself can then be transferred onto the semiconductor substrate. Computer aided design (CAD) tools can be used to assist layout designers with translating the discrete circuit elements into shapes, which will embody the devices themselves in the completed IC device. These shapes make up the individual components of the circuit, such as gate electrodes, diffusion regions, metal interconnects and the like.

The software programs employed by the CAD systems to produce layout representations are typically structured to function under a set of predetermined design rules in order to produce a functional circuit. Often, the design rules are determined by certain processing and design limitations based roughly on the patternability of layout designs. For example, design rules may define the space tolerance between devices or interconnect lines. Once the layout of the circuit has been created, the next step in manufacturing the IC device is to transfer the layout onto the semiconductor substrate. Optical lithography or photolithography is a well-known process for transferring geometric shapes onto the surface on a semiconductor wafer. Photolithography generally begins with the formation of a photoresist layer on the top surface of a semiconductor substrate or wafer. A reticle or mask having certain transmissive regions (e.g., fully light non-transmissive opaque regions such as those formed of chrome, fully light transmissive clear regions such as those formed of quartz, partially transmissive, trilayer, etc.) is then positioned over the photoresist coated wafer.

The mask is placed between a radiation or light source, which can produce light of a pre-selected wavelength (e.g., ultraviolet light) and geometry, and an optical lens system, which may form part of a stepper apparatus. When the light from the light source is directed onto the mask, the light is focused to generate a reduced mask image on the wafer, typically using the optical lens system, which may contain one or several lenses, filters and/or mirrors. This light passes through the clear regions of the mask to expose the underlying photoresist layer, and is blocked by the opaque regions of the mask, leaving that underlying portion of the photoresist layer unexposed. The exposed photoresist layer is then developed, typically through chemical removal of the exposed or unexposed regions of the photoresist layer. The end result is a semiconductor wafer coated with a photoresist layer exhibiting a desired pattern, which defines the geometries, features, lines and shapes of that layer. This pattern can then be used for etching of or controlling deposition into underlying regions of the wafer.

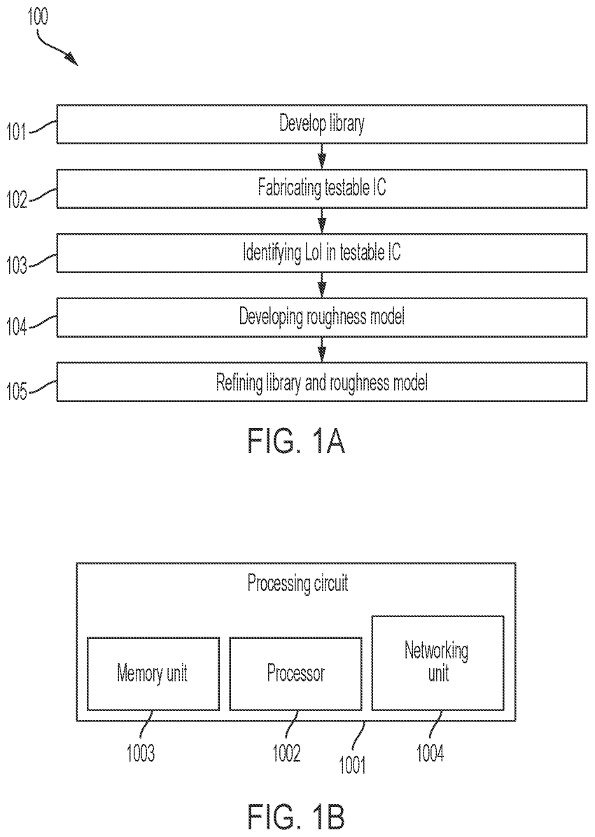

With reference to FIGS. 1A and 1B, a computer-implemented method 100 of assessing surface roughness in metallic lines of an IC is provided. As shown in FIG. 1A, the computer-implemented method 100 includes developing a library of roughness characterizations for metal lines of varying characteristics and dimensions (block 101), fabricating a testable IC (block 102) and identifying, in the testable IC, a location of interest (LoI) at which roughness of a metal line within the LoI could impact IC performance (block 103). In addition, the computer-implemented method 100 includes developing, from the library, a roughness model using the roughness characterizations for those metal lines having characteristics and dimensions corresponding to those of the metal line within the LoI (block 104) and refining the library and the roughness model based on a comparison of the roughness model and an actual roughness of the metal line within the LoI to obtain a final roughness model (block 105).

In accordance with one or more embodiments of the present invention, the metal line within the LoI identified at block 103 can have a length of 7 nm, 5 nm or 3 nm, less than 7 nm or, in some cases, 5 nm or 3 nm. In any case, as noted above, the identified LoI is characterized in that roughness of a metal line within the LoI can impact IC performance as in the case of a 3 nm metal line which has a significant roughness which leads to increased resistance as compared to a similar 3 nm metal line that does not have a significant roughness.

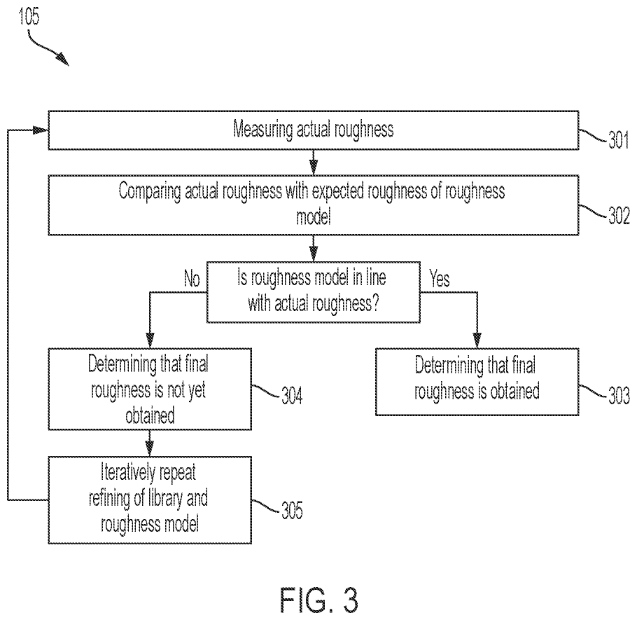

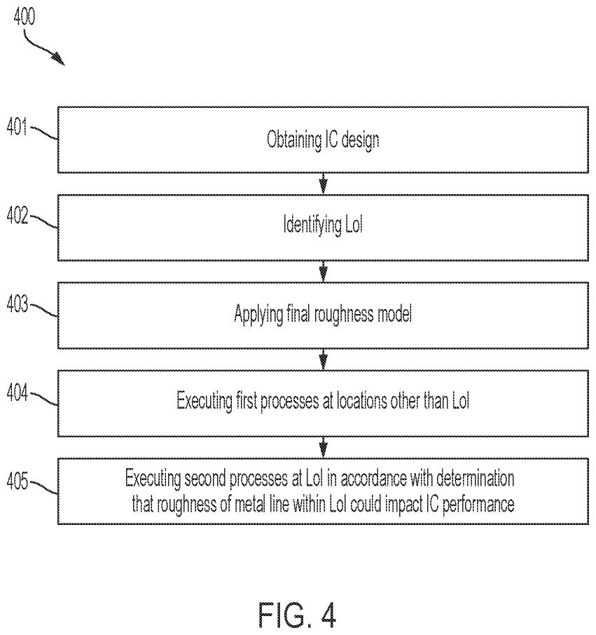

FIG. 1B is a schematic diagram of a processing circuit 1001 by which the computer-implemented method 100 of assessing roughness in the metallic lines of the IC of FIG. 1A is executed. As shown in FIG. 1B, the processing circuit 1001 includes a processor 1002, such as a microprocessor or a central processing unit (CPU) of a computing device, a memory unit 1003 and a networking unit 1004 by which the processor 1002 is communicative with external computing/interface devices. The memory unit 1003 has executable instructions stored thereon that are readable and executable by the processor 1002. These executable instructions include mask-design and other computer-aided design algorithms, which, when read and executed by the processor 1002, cause the processor 1002 to execute at least the computer-implemented method 100 of assessing roughness in the metallic lines of the IC of FIG. 1A and to execute the other operations and functionalities described below (e.g., the computer-implemented methods of FIGS. 3 and 4).

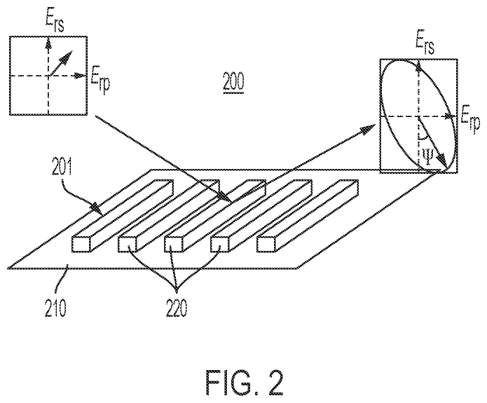

With reference to FIG. 2 and in accordance with one or more embodiments of the present invention, the developing of the library of roughness characterizations of block 101 (shown in FIG. 1) can include inline optical metrology for critical dimension (CD) measurement. This, in turn, can involve scatterometry of grating structures where grating structures are built to be representative of multiple types of metal lines having different surface roughness. Because metal lines in an IC can be provided in a trench or as a via, each with a CD, certain dimensions of height, width and length as well as side wall angles (SWAs), the grating structures can be built with varying characteristics and dimensions to be representative of metal lines in the form of a trench or a via, each with a CD, a certain dimensions of height, width and length as well as side wall angles (SWAs).

As shown in FIG. 2, the scatterometry of a grating structure 201 by an optical simulator 200 is illustrated. The grating structure 201 includes a substrate 210 and a series of periodic gratings 220 arranged in a periodic side-by-side formation to mimic roughness of a metal line with certain predefined characteristics and dimensions in an IC. Light is emitted toward the grating structure 201 and reflects in a direction based on how the light is incident on the gratings 220. The optical simulator 200 is thus is used to generate an optical response for the metal line within the LoI or the structure of interest (i.e., as a forward problem) and so that a regression-based or library-based approach can be used to extract feature dimensions/additional information (i.e., as a reverse problem).

With reference to FIG. 3, the refining of the library and the roughness model to obtain a final roughness model of block 105 can be executed by the processing circuit 1001 of FIG. 1B and can include measuring an actual roughness of the metal line within the LoI (block 301) and comparing the actual roughness with an expected roughness derived from the roughness model (block 302). As shown in FIG. 3, in an event the comparison of block 302 suggests that the expected roughness of the roughness model is in line with the actual roughness of the metal line within the LoI, it is determined that the final roughness model has been obtained (block 303). Conversely, in an event the comparison of block 302 suggests that the expected roughness of the roughness model is not in line with the actual roughness of the metal line within the LoI, it is determined that the final roughness model has not yet been obtained (block 304) and the refining of the library and the roughness model to obtain a final roughness model of block 105 is iteratively repeated (block 305).

With reference to FIG. 4, a computer-implemented method 400 of assessing roughness in metallic lines of an integrated circuit (IC) is provided. As shown in FIG. 4, the computer-implemented method 400 can be executed by the processing circuit 1001 of FIG. 1A and includes obtaining an IC design (block 401), identifying a location of interest (LoI) in the IC design at which roughness of a metal line within the LoI could impact IC performance (block 402) and applying a final roughness model to the IC design to model a roughness of the metal line within the LoI to determine whether the roughness of the metal line within the LoI could impact IC performance (block 403). The computer-implemented method 400 can further include executing first processes to fabricate the IC design without regard to limiting metal line roughness at locations other than the LoI (block 404) and executing second processes for limiting metal line roughness or the first processes to fabricate the IC design within the LoI in accordance with determinations that the roughness of the metal line within the LoI could or will not impact IC performance, respectively (block 405).

In accordance with one or more embodiments of the present invention, the metal line within the LoI identified at block 402 can have a length of 7 nm, 5 nm or 3 nm, less than 7 nm or, in some cases, 5 nm or 3 nm. In any case, as noted above, the identified LoI is characterized in that roughness of a metal line within the LoI can impact IC performance as in the case of a 3 nm metal line which has a significant roughness which leads to increased resistance as compared to a similar 3 nm metal line that does not have a significant roughness.

In accordance with one or more embodiments of the present invention, the first and second processes of blocks 404 and 405 differ from one another in significant ways. The first processes can be executed for relatively large-scale processing at low cost and in short time. By contrast, the second processes serve too limit metal line roughness within the LoI but can be cost prohibitive and time-consuming. As such, it is desirable to limit an amount the second processes are used to only those LoIs that are identified in block 402 (and in block 103 of FIG. 1A) and, of those, to only those metal lines for which determinations are made that their roughness could impact IC performance.

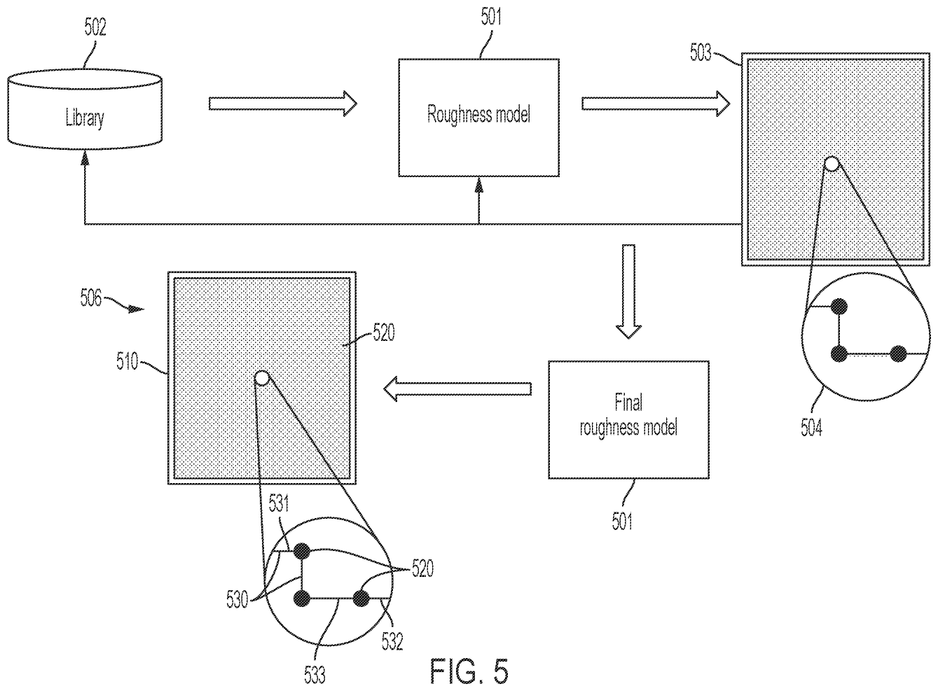

With reference to FIG. 5, a process flow of the various methods described above is provided. As shown in FIG. 5, a roughness model 501 is developed from a library 502 of roughness characterizations for metal lines of varying characteristics and dimensions. A testable IC 503 is then built and an LoI 504 in the testable IC 503, at which roughness of a metal line within the LoI could impact IC performance, is identified. The expected roughness of the metal line within the LoI, which is derived from the roughness model is then compared with an actual roughness of the metal line within the LoI so that the roughness model and the library can be iteratively refined to obtain the final roughness model 505. The final roughness model 505 is then used to facilitate a fabrication of an IC 506 from an IC design by informing a foundry or a fabrication tool as to rules for fabricating the IC 506. That is, the final roughness model 505 allows the foundry or the fabrication tool to produce the IC 506 using the first processes (see above) to fabricate the IC 506 without regard to limiting metal line roughness at locations other than the LoI and using the second processes (see above) to limit metal line roughness within the LoI for those cases where metal line roughness is expected to impact IC performance.

The result is that the IC 506 includes a substrate 510, electronic elements 520 deployed on the substrate 510 and metal lines 530. The metal lines 530 are disposed to interconnect the electronic elements 520 to one another. To this end, the metal lines 530 include at least first, second and third metal lines 531, 532 and 533 of varying scales (e.g., 7 nm for the first metal lines 531, 5 nm for the second metal lines 532 or 3 nm for the third metal lines 533) with substantially similar roughness characteristics as well as large scale metal lines. As such, especially for the second and third metal lines 532 and 533, because their roughness is substantially similar to that of the first metal lines 531, the second and third metal lines 532 and 533 do not present a risk of a negative impact on performance of the IC 506. Moreover, because the second processes are only used to fabricate certain parts of the IC 506 where determinations are made as to metal line roughness potentially affecting IC performance, the use of the second processes in the overall fabrication does not substantially increase costs or the time required to complete the fabrication while increasing yields.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method of assessing roughness in metallic lines of an integrated circuit (IC), the computer-implemented method comprising:
developing a library of roughness characterizations for metal lines of varying characteristics and dimensions;
fabricating a testable IC;
identifying, in the testable IC, a location of interest (LoI) at which roughness of a metal line within the LoI could impact IC performance;
developing, from the library, a roughness model using the roughness characterizations for those metal lines having characteristics and dimensions corresponding to those of the metal line within the LoI; and
refining the library and the roughness model based on a comparison of the roughness model and an actual roughness of the metal line within the LoI to obtain a final roughness model.

2. The computer-implemented method according to claim 1, wherein the developing of the library of roughness characterizations comprises inline optical metrology for critical dimension (CD) measurement.

3. The computer-implemented method according to claim 2, wherein the inline optical metrology for CD measurement comprises scatterometry of grating structures.

4. The computer-implemented method according to claim 2, wherein the varying characteristics and dimensions of the metal lines comprise a trench or via CD, height and side wall angle (SWA).

5. The computer-implemented method according to claim 1, wherein the metal line within the LoI has a length of 7 nm, 5 nm or 3 nm.

6. The computer-implemented method according to claim 1, wherein the metal line within the LoI has a length of 3 nm.

7. The computer-implemented method according to claim 1, wherein the refining of the library and the roughness model comprises:
measuring an actual roughness of the metal line within the LoI; and
comparing the actual roughness with an expected roughness derived from the roughness model.

8. The computer-implemented method according to claim 1, further comprising repeating the refining of the library and the roughness model to iteratively obtain the final roughness model.

9. The computer-implemented method according to claim 1, further comprising:
applying the final roughness model to an IC design to identify, in the IC design, an LoI; and
fabricating an IC according to the IC design, the fabricating comprising executing first processes without regard to limiting metal line roughness at locations other than the LoI and executing second processes for limiting metal line roughness within the LoI.

10. A computer-implemented method of fabricating an integrated circuit (IC) using assessed roughness in metallic lines, the computer-implemented method comprising:
obtaining an IC design;
identifying a location of interest (LoI) in the IC design at which roughness of a metal line within the LoI could impact IC performance;
applying a final roughness model to the IC design to model a roughness of the metal line within the LoI to determine whether the roughness of the metal line within the LoI could impact IC performance;
executing first processes to fabricate the IC design without regard to limiting metal line roughness at locations other than the LoI; and
executing second processes for limiting metal line roughness or the first processes to fabricate the IC design within the LoI in accordance with determinations that the roughness of the metal line within the LoI could or will not impact IC performance, respectively.

11. The computer-implemented method according to claim 10, wherein the metal line within the LoI has a length of 7 nm, 5 nm or 3 nm.

12. The computer-implemented method according to claim 10, wherein the metal line within the LoI has a length of 3 nm.

13. The computer-implemented method according to claim 10, further comprising:
developing a library of roughness characterizations for metal lines of varying characteristics and dimensions;
fabricating a testable IC;
identifying an LoI in the testable IC;
developing, from the library, a roughness model using the roughness characterizations for those metal lines having characteristics and dimensions corresponding to those of the metal line within the LoI in the testable IC; and
refining the library and the roughness model based on a comparison of the roughness model and an actual roughness of the metal line within the LoI in the testable IC to obtain the final roughness model.

14. The computer-implemented method according to claim 13, wherein the developing of the library of roughness characterizations comprises inline optical metrology for critical dimension (CD) measurement.

15. The computer-implemented method according to claim 13, wherein the inline optical metrology for critical dimension (CD) measurement comprises scatterometry of grating structures.

16. The computer-implemented method according to claim 13, wherein the varying characteristics and dimensions of the metal lines comprise a trench or via CD, height and side wall angle (SWA).

17. The computer-implemented method according to claim 13, wherein the refining of the library and the roughness model comprises:
measuring an actual roughness of the metal line within the LoI; and
comparing the actual roughness with an expected roughness derived from the roughness model.

18. The computer-implemented method according to claim 13, further comprising repeating the refining of the library and the roughness model to iteratively obtain the final roughness model.

19. An integrated circuit (IC), comprising:
a substrate;
electronic elements deployed on the substrate; and
metal lines disposed to interconnect the electronic elements to one another,
the metal lines comprising at least first, second and third metal lines of varying scales with substantially similar roughness characteristics.

20. The IC according to claim 19, wherein the first metal lines are 7 nm metal lines, the second metal lines are 5 nm metal lines and the third metal lines are 3 nm metal lines.
